(19) United States
(12) Patent Application Publication
(10) Pub. No.: US 2021/0295747 A1
(43) Pub. Date: Sep. 23, 2021

(54) FLEXIBLE DISPLAY DEVICE

(71) Applicant: Wuhan China Star Optoelectronics Semiconductor Display Technology Co., Ltd., Wuhan (CN)

(72) Inventor: Guodong JIANG, Wuhan (CN)

(21) Appl. No.: 16/323,515

(22) PCT Filed: Aug. 24, 2018
(86) PCT No.: PCT/CN2018/102146

§ 371 Date: Feb. 5, 2019

(30) Foreign Application Priority Data
Jul. 19, 2018 (CN) 201810801638.3

(51) Int. Cl. G09F 9/30

(52) U.S. Cl. CPC G09F 9/301

(57) ABSTRACT

A flexible display device comprises a substrate, a flexible display element disposed on the substrate; a resilient layer disposed on a side of the substrate away from the flexible display element. The flexible display device utilizes the resilient layer to bend from a flat state to a bending state, and to restore from the bending state to the flat state.

### FIELD OF INVENTION

The present disclosure relates to the field of display products, and more particularly to a flexible display device.

### BACKGROUND OF INVENTION

With development of mobile terminals, mobile terminals having a large screen are increasingly popular.

With increasing screen sizes, the mobile terminals have problems of increasing size and poor portability. Flexible display devices having a bending property are produced to solve the problem. Display devices having a large screen can realize portability by bending itself for a reason that the flexible display devices can work within a certain deformation.

However, the current flexible display devices have problems of low speeds of bending and restoring. A new flexible display device should be provided to improve bending speed and restoring speed.

### SUMMARY OF INVENTION

The present disclosure provides a flexible display device to improve speed of bending and restoring.

The present disclosure provides a flexible display device comprises

a substrate; a flexible display element disposed on the substrate; a resilient layer disposed on a side of the substrate away from the flexible display element, bending the flexible display device from a flat state to a bending state, and restoring the flexible display device from the bending state to the flat state; wherein constituent materials of the resilient layer comprise nickel-based amorphous metal or zirconium-based amorphous metal; and wherein a thickness of the resilient layer ranges from 30 microns to 80 microns.

In an embodiment of the present disclosure, the resilient layer comprises at least two flexible elements apart from each other, disposed on a side of the substrate away from the flexible display element.

In an embodiment of the present disclosure, the resilient layer comprises at least a through slot.

In an embodiment of the present disclosure, the flexible display device comprises a first fixed layer, and the flexible device comprises a bending area and a non-bending area; and the first fixed layer is disposed on the non-bending area and between the substrate and the resilient layer, and the first fixed layer fixes the resilient layer and the substrate together.

In an embodiment of the present disclosure, constituent materials of the first fixed layer comprises an optical adhesive or double faced adhesive.

In an embodiment of the present disclosure, the flexible display device comprises a supporting sheet disposed between the substrate and the resilient layer.

In an embodiment of the present disclosure, constituent materials of the supporting sheet comprise polyethylene glycol terephthalate or foam materials.

In an embodiment of the present disclosure, the flexible display device comprises a second fixed layer disposed between the supporting sheet and the substrate; the second fixed layer fixes the supporting sheet and the substrate together.

In an embodiment of the present disclosure, constituent materials of the second fixed layer comprise an optical adhesive.

The present disclosure provides a flexible display device comprises a substrate; a flexible display element disposed on the substrate; a resilient layer disposed on a side of the substrate away from the flexible display element, bending the flexible display device from a flat state to a bending state, and restoring the flexible display device from the bending state to the flat state.

In an embodiment of the present disclosure, constituent materials of the resilient layer comprise nickel-based amorphous metal or zirconium-based amorphous metal.

In an embodiment of the present disclosure, a thickness of the resilient layer ranges from 30 microns to 80 microns.

In an embodiment of the present disclosure, the resilient layer comprises at least two flexible elements apart from each other, disposed on a side of the substrate away from the flexible display element.

In an embodiment of the present disclosure, the resilient layer comprises at least a through slot.

In an embodiment of the present disclosure, the flexible display device comprises a first fixed layer, and the flexible device comprises a bending area and a non-bending area; and the first fixed layer is disposed on the non-bending area and between the substrate and the resilient layer, and the first fixed layer fixes the resilient layer and the substrate together.

In an embodiment of the present disclosure, constituent materials of the first fixed layer comprise an optical adhesive or double faced adhesive.

In an embodiment of the present disclosure, the flexible display device comprises a supporting sheet disposed between the substrate and the resilient layer.

In an embodiment of the present disclosure, constituent materials of the supporting sheet comprise polyethylene glycol terephthalate or foam materials.

In an embodiment of the present disclosure, the flexible display device comprises a second fixed layer disposed between the supporting sheet and the substrate; the second fixed layer fixes the supporting sheet and the substrate together.

In an embodiment of the present disclosure, constituent materials of the second fixed layer comprise an optical adhesive.

The present disclosure can improve speeds of bending and restoring by disposing the resilient layer, which can assist the flexible display device in bending and restoring, on a side of the substrate away from the flexible display element.

Aforementioned contents of the present disclosure will be better understood with reference to the following description, appended claims and accompanying figures.

### DESCRIPTION OF DRAWINGS

FIG. 1 is a first structural schematic diagram of a flexible display device according to the present invention.

FIG. 2 is a second structural schematic diagram of a flexible display device according to the present invention.

FIG. 3 is a third structural schematic diagram of a flexible display device according to the present invention.

FIG. 4 is a fourth structural schematic diagram of a flexible display device according to the present invention.

FIG. 5 is a fifth structural schematic diagram of a flexible display device according to the present invention.

### DETAILED DESCRIPTION OF PREFERRED EMBODIMENTS

The following description of every embodiment with reference to the accompanying drawings is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present disclosure. Examples of the described embodiments are given in the accompanying drawings, wherein the identical or similar reference numerals constantly denote the identical or similar elements or elements having the identical or similar functions.

Reference throughout the specification to “embodiment” means that a particular feature, structure, or characteristic described in connection with the embodiment is included in at least one embodiment. Thus, appearances of the phrases “embodiment” in places throughout the specification are may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present invention.

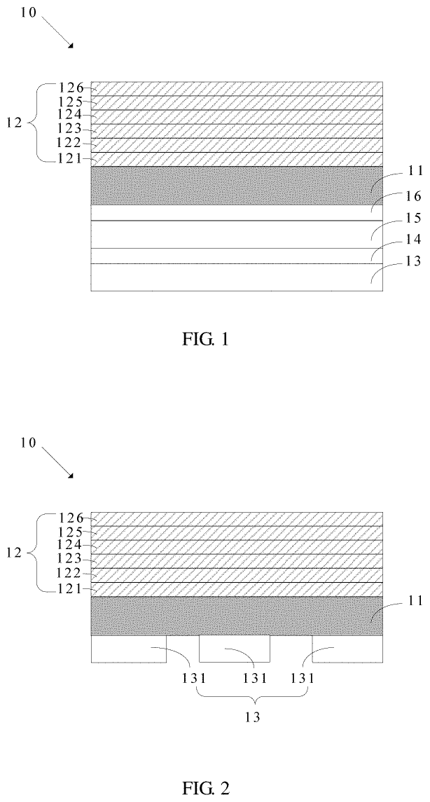

The present disclosure provides a flexible display device. As shown in FIG. 1, FIG. 1 is a structural schematic diagram of a flexible display device according to the present disclosure. The flexible display device 10 comprises a substrate 11, a flexible display element 12, and a resilient layer 13.

Wherein the substrate 11 is a flexible substrate. The substrate 11 may be a metal foil, a thin glass, a plastic substrate, and so on. The substrate is configured to dispose thereon the flexible display element 12.

The flexible display element 12 can be a flexible organic light-emitting display element, a flexible liquid crystal display element, a flexible electrophoretic display element and so on, where kinds of the flexible display element 12 are not limited herein. According to some disclosures, as shown in FIG. 1, the flexible display element 12 comprises a thin-film transistor layer 121, an organic light-emitting layer 122, an encapsulation layer 123, a polarizer 124, a touch layer 125, and a cover plate 126 which are sequentially stacked with one another. The thin-film transistor 121 is configured to drive the organic light-emitting layer 122. The thin-film transistor 121 is disposed on the substrate 11. The encapsulation layer 123 is configured to insulate external water and oxygen. The encapsulation layer 123 is a thin-film encapsulation layer generated by a combination of many organic-inorganic films for optimization. The polarizer 124 configured to adjust incident external light is secured on the encapsulation layer 123 by coating an optical adhesive on the encapsulation layer 123. A couple of touch electrodes configured to realize touch operation are disposed on the touch layer 125. The cover plate 126 having a high hardness characteristic is disposed thereon a layer having a frictional resistance and is able to increase a frictional resistance for the cover plate 126.

As shown in FIG. 2, the resilient layer 13 is disposed on a side of the substrate 11 away from the flexible display element 12. The resilient layer is made of materials having memory properties, self-healing properties, and resilience properties. The resilient layer 13 can make other structures of the flexible display device 10 bending, when the flexible display device 10 is bending. The resilient layer 13 helps bend the flexible display device 10 from a flat state to a bending state. Furthermore, the resilient layer 13 can not only improve speed of restoring the flexible display device 10 from the bending state to the flat state, but also can reduce wrinkles of the flexible display device 10.

According to some embodiments, the resilient layer 13 is made of metal materials that the metal materials have resilience. The resilient layer 13 is made of nickel-based amorphous metal or zirconium-based amorphous metal for optimization. A thickness of the resilient layer 13 ranges from 30 microns (μm) to 80 microns (μm).

According to some embodiments, the resilient layer 13 includes at least two flexible elements 131. As shown in FIG. 2, the at least two flexible elements 131 are apart from each other and disposed on a side of the substrate 11 away from the flexible display element 12.

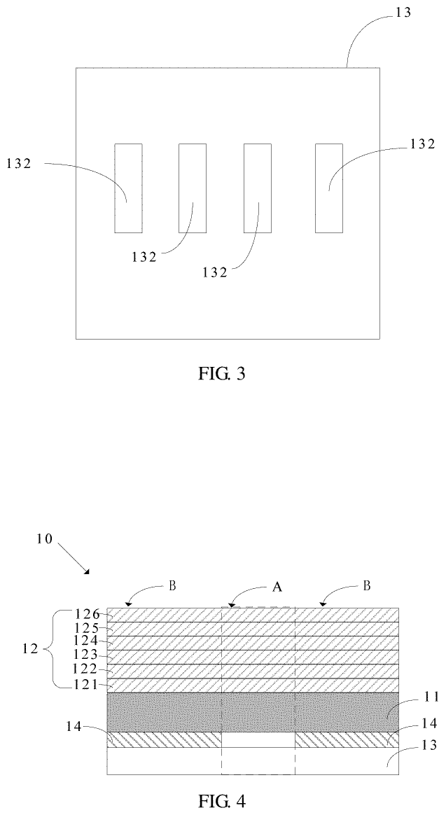

Producing at least two flexible elements 131 according to predetermined specification, and then disposing the at least two flexible elements 131 on a side of the substrate 11 away from the flexible display device 12. According to some embodiments, as shown in FIG. 3, disposing at least a through slot 132 on the resilient layer 13 in advance, and then disposing the resilient layer 13 on the side of the substrate 11 away from the flexible display element 12.

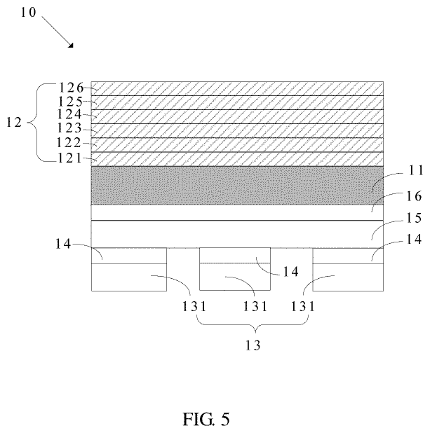

As shown in FIG. 4, the flexible display device 10 also comprises a first fixed layer 14. The first fixed layer 14 is disposed between the resilient layer 13 and the substrate 11 is configured to secure the resilient layer 13 with the substrate 11. Constituent materials of the first fixed layer 14 comprise an optical adhesive or a double sided tape. As shown in FIG. 4, the flexible display device 10 also comprises a bending area A and a non-bending area B. The bending area A is configured to make the flexible display device 10 bend. The first fixed layer 14 is just disposed on the non-bending area B for a reason that an optical adhesive or double faced adhesive of the bending area A is wrinkled and is not easy to restore to the flat state, when the flexible display device is bended. As shown in FIG. 5, just coating the optical adhesive or double faced adhesive on a corresponding area between the substrate 11 and the flexible elements 131 to generate the first fixed layer 14, when the at least two flexible 131 are disposed on a side of the substrate 11 away from the flexible display element 12.

As shown in FIG. 1, the flexible display device 10 also comprises a supporting sheet 15. Constituent materials of the supporting sheet comprise polyethylene glycol terephthalate or foam materials. The supporting sheet 15 is disposed between the substrate 11 and the resilient layer 13 plays an ancillary shoring role. Furthermore, the supporting sheet 15 can relieve pressure when the flexible display device 10 is under pressure, and can reduce stress when the flexible display device 10 is bended. As shown in FIG. 1, the first fixed layer 14 is disposed between the supporting sheet 15 and the resilient layer 13 to fix the supporting sheet 15 and the resilient layer 13 together.

As shown in FIG. 1, the flexible display device 10 also comprises a second fixed layer 16. The second fixed layer 16 is disposed between the supporting sheet 15 and the substrate 11 to fix the supporting sheet 15 and the substrate 11 together. Constituent materials of the second fixed layer 16 comprise an optical adhesive specifically. As the same with the first fixed layer 14, the second fixed layer 16 is also disposed on the non-bending area B to reduce wrinkles when the flexible display device 10 is bended.

The present disclosure can improve speeds of bending and restoring by disposing the resilient layer on a side of the substrate away from the flexible display element, and the resilient layer can assist the flexible display device to bend and restore well.

The present disclosure is described in detail in accordance with the above contents with the specific preferred examples. However, this present disclosure is not limited to the specific examples. For a person of ordinary skill in the art, on the premise of keeping the conception of the present disclosure, the technical personnel can also make simple deductions or replacements, all of which should be considered to belong to the protection scope of the present disclosure.

1. A flexible display device comprising:
a substrate;
a flexible display element disposed on the substrate; and
a resilient layer disposed on a side of the substrate away from the flexible display element, bending the flexible display device from a flat state to a bending state, and restoring the flexible display device from the bending state to the flat state;
wherein constituent materials of the resilient layer comprise nickel-based amorphous metal or zirconium-based amorphous metal; and
wherein a thickness of the resilient layer ranges from 30 microns to 80 microns.

2. The flexible display device as claimed in claim 1, wherein the resilient layer comprises at least two flexible elements apart from each other, disposed on a side of the substrate away from the flexible display element.

3. The flexible display device as claimed in claim 1, wherein the resilient layer comprises at least a through slot.

4. The flexible display device as claimed in claim 1, wherein the flexible display device comprises a first fixed layer, and the flexible device comprises a bending area and a non-bending area; and the first fixed layer is disposed on the non-bending area and between the substrate and the resilient layer, and the first layer fixes the resilient layer and the substrate together.

5. The flexible display device as claimed in claim 4, wherein constituent materials of the first fixed layer comprise an optical adhesive or a double sided tape.

6. The flexible display device as claimed in claim 1, wherein the flexible display device comprises a supporting sheet disposed between the substrate and the resilient layer.

7. The flexible display device as claimed in claim 6, wherein constituent materials of the supporting sheet comprise polyethylene glycol terephthalate or foam materials.

8. The flexible display device as claimed in claim 6, wherein the flexible display device comprises a second fixed layer disposed between the supporting sheet and the substrate; the second fixed layer fixes the supporting sheet and the substrate together.

9. The flexible display device as claimed in claim 8, wherein constituent materials of the second fixed layer comprise an optical adhesive.

10. A flexible display device comprising:
a substrate;
a flexible display element disposed on the substrate; and
a resilient layer disposed on a side of the substrate away from the flexible display element, bending the flexible display device from a flat state to a bending state, and restoring the flexible display device from the bending state to the flat state.

11. The flexible display device as claimed in claim 10, wherein constituent materials of the resilient layer comprise nickel-based amorphous metal or zirconium-based amorphous metal.

12. The flexible display device as claimed in claim 10, wherein a thickness of the resilient layer ranges from 30 microns to 80 microns.

13. The flexible display device as claimed in claim 10, wherein the resilient layer comprises at least two flexible elements apart from each other, disposed on a side of the substrate away from the flexible display element.

14. The flexible display device as claimed in claim 10, wherein the resilient layer comprises at least a through slot.

15. The flexible display device as claimed in claim 10, wherein the flexible display device comprises a first fixed layer, and the flexible device comprises a bending area and a non-bending area; and the first fixed layer is disposed on the non-bending area and between the substrate and the resilient layer, and the first fixed layer fixes the resilient layer and the substrate together.

16. The flexible display device as claimed in claim 15, wherein constituent materials of the first fixed layer comprise an optical adhesive or double sided tape.

17. The flexible display device as claimed in claim 10, wherein the flexible display device comprises a supporting sheet disposed between the substrate and the resilient layer.

18. The flexible display device as claimed in claim 17, wherein constituent materials of the supporting sheet comprise polyethylene glycol terephthalate or foam materials.

19. The flexible display device as claimed in claim 17, wherein the flexible display device comprises a second fixed layer disposed between the supporting sheet and the substrate, and the second fixed layer fixes the supporting sheet and the substrate together.

20. The flexible display device as claimed in claim 19, wherein constituent materials of the second fixed layer comprise an optical adhesive.
